(19) United States
(12) Patent Application Publication
(10) Pub. No.: US 2009/0051672 A1
(43) Pub. Date: Feb. 26, 2009

(54) Electro-wetting display device with touch mode

(75) Inventors: Wen-Hua Chen, Miao-Li (TW); Miao-Sung Huang, Miao-Li (TW); Hsiang-Hui Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/229,631

(22) Filed: Aug. 25, 2008

(30) Foreign Application Priority Data
Aug. 24, 2007 (CN) 200710076569.6

(51) Int. Cl. G06F 3/042

(52) U.S. Cl. 345/175

(57) ABSTRACT

An exemplary electro-wetting display device includes a first substrate, a second substrate opposite to the first substrate, a first polar liquid disposed between the first and second substrates, a second, colored, non-polar liquid disposed between the first and second substrates, and a touch system disposed adjacent to the first substrate. The second liquid is immiscible with the first liquid. The touch system is configured for sensing outside touches and locating the touching position.

### FIELD OF THE INVENTION

The present invention relates to display devices, and more particularly to an electro-wetting display device having a touch mode function.

### GENERAL BACKGROUND

Thin film transistor liquid crystal displays (TFT-LCDs) and polymer LED displays are widely used in laptop computers and mobile telephones. In addition to these types of displays, other display techniques, such as electro-wetting display (EWD) devices, which are suitable for flat plate displays are evolving. The electro-wetting functionality provides displays with excellent brightness and contrast, and relatively low power consumption compared to many other display technologies.

With the development of technology in the EWD display field, advanced operation functions including touch mode function for the EWD devices is demanded.

It is, therefore, desired to provide an EWD device that can overcome the above-described shortcoming.

### SUMMARY

An exemplary EWD device includes a first substrate, a second substrate opposite to the first substrate, a first polar liquid disposed between the first and second substrates, a second, colored, non-polar liquid disposed between the first and second substrates, and a touch system disposed adjacent to the first substrate. The second liquid is immiscible with the first liquid. The touch system is configured for sensing touches and locating the touching position.

Other novel features and advantages will become more apparent from the following detailed description when taken in conjunction with the accompanying drawings.

### BRIEF DESCRIPTION OF THE DRAWINGS

FIG. 1 is a side, cross-sectional view of parts of an EWD device according to a first embodiment of the present invention.

FIG. 2 is a side, cross-sectional view of parts of an EWD device according to a second embodiment of the present invention.

FIG. 3 is a side, cross-sectional view of a pixel unit of an EWD device according to a third embodiment of the present invention.

FIG. 4 is a side, cross-sectional view of a pixel unit of an EWD device according to a fourth embodiment of the present invention.

### DETAILED DESCRIPTION OF PREFERRED EMBODIMENTS

Reference will now be made to the drawings to describe preferred and exemplary embodiments of the present invention in detail.

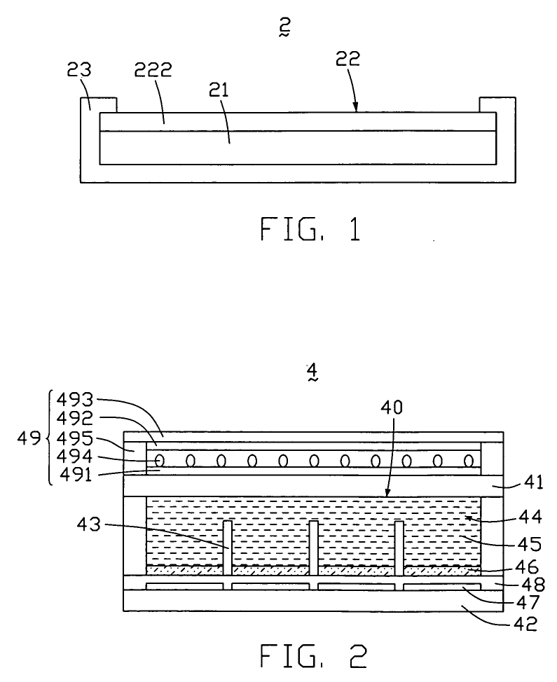

Referring to FIG. 1, a side, cross-sectional view of parts of an EWD device 2, according to a first embodiment, of the present invention is shown. The EWD device 2 includes an EWD panel 21 for displaying images, a touch panel 22 for sensing external touches, and a frame 23 for receiving the EWD panel and the touch panel 22. The EWD panel 21 includes a sensor circuit (not shown) for sensing touches and a substrate 222 having the sensor circuit implanted thereof.

Referring to FIG. 2, a side, cross-sectional view of parts of an EWD device 4 according to a second embodiment of the present invention is shown. The EWD device 4 includes a first substrate 41, a second substrate 42 disposed parallel to and spaced apart from the first substrate 41, and a plurality of side walls 43 interposed between the first and second substrates 41, 42. The side walls 43 are arranged in a matrix and cooperate with the first and second substrates 41, 42 to form a plurality of receiving spaces 44. The side walls 43 also divide the EWD device 4 into a multiplicity of pixel units 40 in an array type. The first substrate 41 is made of transparent material, such as glass, plastic or the like.

The receiving space 44 of each of the pixel units 40 is filled with a first liquid 45 and a second liquid 46. The first liquid 45 is polar, conductive water solution or salt solution, such as a solution mixed with Ethyl Alcohol and potassium chloride solution. The second liquid 46 is non-polar, opaque, and is insulative, such as oil, alkane, hexadecane or the like. The second liquid 46 can be colored with a dye (or in some cases pigment), and serves as a shielding liquid. The first and second liquid 45, 46 are immiscible.

The second substrate 42 includes a plurality of pixel electrodes 47 arranged thereon, and an insulating layer 48 covering these pixel electrodes 47. The insulating layer 48 is adjacent to the pixel units 40, and insulates the pixel electrodes 47 from the pixel units 40. The pixel electrodes 47 are arranged in a pattern substantially corresponding to the array of the pixel units 40. The insulating layer 48 can be made of hydrophobic material, such as an amorphous fluoropolymer.

The EWD device 4 further includes a touch system 49 disposed on the first substrate 41 but away from the first liquid 45. The touch system 49 includes a first transparent conductive layer 491, a second transparent conductive layer 492, a transparent touching layer 493, a plurality of spacers 494, and a sealant 495. The first transparent conductive layer 491 is disposed on the first substrate 41, and is opposite to the second transparent conductive layer 492 with the spacers 494 dispersed uniformly therebetween. The first and second transparent conductive layers 491, 492 both are interposed between the transparent touching layer 493 and the first substrate 41. The touching layer 493, the second transparent conductive layer 492, the spacers 494, the first transparent conductive layer 491, and the first substrate 41 are incorporated by the sealant 495. The transparent touching layer 493 can be made of transparent film material, or glass. The spacers 494 can be made of light transmissive material.

When the EWD device 4 is in operation, each of the pixel units 40 has a voltage difference between the first liquid 45 and the corresponding pixel electrode 47. The first liquid 45 reacts to the electric field generated thereof and the second liquid 46 is non-responsive to the electric field. The first liquid 45 reacts by flowing under the influence of the electric field and pushes parts of the second liquid 46 aside, thereby allowing light to pass through parts of the insulating layer 48 not shielded by the second liquid 46. As the voltage difference between the first liquid 45 and the corresponding pixel electrode 47 varies, the area of the pixel unit 40 shielded by the second liquid 46 varies.

The first and second transparent conductive layers 491, 492 have electrical signals applied thereto. When a user of the EWD device 4 touches, with enough force, the transparent touching layer 493, the first and the second transparent conductive layers 491, 492 comes into contact with each other and the electrical resistance between the first and second transparent conductive layers 491, 492 changes at this point of contact, thus the point on the transparent touching layer 493, the user touched, can be located exactly. As a result, the EWD device can respond functionally to user touches.

The EWD device 4 includes the touch system 49 disposed on the first substrate 41, therefore the EWD device 4 can achieve improved reliability and anti-vibration besides cost-down.

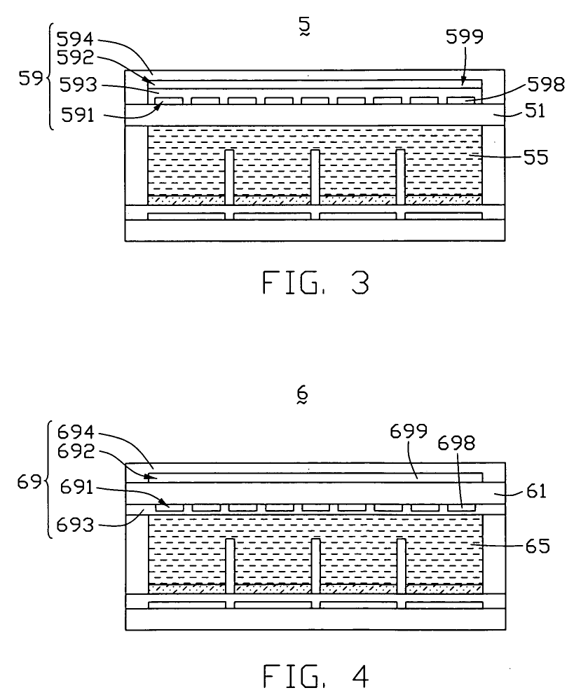

Referring to FIG. 3, a side, cross-sectional view of parts of an EWD device 5 according to a third embodiment of the present invention is shown. The EWD device 5 has a similar structure as the EWD device 4. However, a touch system 59 includes a first transparent conductive layer 591, a second transparent conductive layer 592, a first insulating layer 593, and a second insulating layer 594. The first transparent conductive layer 591 is disposed on a first substrate 51 but away from a first liquid 55. The first insulating layer 593 is disposed on the first transparent conductive layer 591 and the first substrate 51. The second insulating layer 594 is disposed on the first insulating layer 593. The first transparent conductive layer 591 includes a plurality of rows of parallel conductive lines 598. The second transparent conductive layer 592 includes a plurality of columns of parallel conductive lines 599. The first and second transparent conductive lines 598, 599 constitute a plurality of capacitors arranged in a matrix.

When the EWD device 5 operates, the first and second transparent conductive lines 598, 599 have electric signals applied thereto, respectively. When a user touches the second insulating layer 594, a capacitance at the touched position is changed and that touched position is identified.

Referring to FIG. 4, a side, cross-sectional view of parts of an EWD device 6 according to a fourth embodiment of the present invention is shown. The EWD device 6 has a similar structure as the EWD device 5. However, a touch system 69 includes a first transparent conductive layer 691, a second transparent conductive line 692, a first insulating layer 693, and a second insulating layer 694. The first transparent conductive layer 691 is disposed on a first substrate and adjacent to a first liquid 65. The first insulating layer 693 is disposed on the first substrate 61 covering the first transparent conductive lines 691. The second transparent conductive layer 692 is disposed on the first substrate 61 but away from the first liquid 65. The second insulating layer 694 is disposed on the second transparent conductive layer 692 and the first substrate 61. The first transparent conductive layer 691 includes a plurality of rows of parallel conductive lines 698. The second transparent conductive layer 692 includes a plurality of columns of parallel conductive lines 699. The first and second transparent conductive lines 698, 699 constitute a plurality of capacitors arranged in a matrix.

The EWD device 6 has the first and second transparent conductive lines 698, 699 arranged at two opposite sides of the first substrate 61, thus the capacitors constituted thereof are uniform and the identification of the touching position is accurate.

In alternative embodiments, the capacitors that are sensitive to outside touches can be replaced by resistors that are sensitive to outside touches.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. An electro-wetting display device, comprising:
a first substrate;
a second substrate opposite to the first substrate;
a first polar liquid disposed between the first and second substrates;
a second, colored, non-polar liquid disposed between the first and second substrates, and the second liquid being immiscible with the first liquid;
a transparent touching layer disposed on the first substrate away from the second substrate;
a first conductive layer; and
a second conductive layer;
wherein the first and second conductive layers are disposed between the first substrate and the transparent touching layer;
wherein the first conductive layer is adjacent to the first substrate and the second conductive layer is adjacent to the transparent touching layer.

2. The electro-wetting display device of claim 1, further comprising a plurality of side walls interposed between the first and second substrates and cooperating with the first and second substrates to form a plurality of pixel units.

3. The electro-wetting display device of claim 1, further comprising a sealant disposed between the first substrate and the transparent touching layer.

4. The electro-wetting display device of claim 1, further comprising an insulating layer disposed between the first and second conductive layers.

5. The electro-wetting display device of claim 1, wherein the first and second conductive layers cooperatively constitute plural capacitors.

6. An electro-wetting display device, comprising:
a first substrate;
a second substrate opposite to the first substrate;
a first polar liquid disposed between the first and second substrates;
a second, opaque, non-polar liquid disposed between the first and second substrates, and the second liquid being immiscible with the first liquid;
a first insulating layer;
a first conductive layer; and
a second conductive layer;
wherein the first and second conductive layers are disposed on two opposite sides of the first substrate;
wherein the first conductive layer is adjacent to the second substrate and the second conductive layer is away from the second substrate, and the first insulating layer is disposed on the first conductive layer.

7. The electro-wetting display device of claim 6, wherein the first conductive layer comprises a plurality of first conductive lines parallel to each other, and the second conductive layer comprises a plurality of second conductive lines parallel to each other and orthogonal to the first conductive lines.

8. The electro-wetting display device of claim 7, further comprising a second insulating layer disposed on the first insulating layer and the second conductive lines.

9. An electro-wetting display device, comprising:
a first substrate;
a second substrate opposite to the first substrate;
a first polar liquid disposed between the first and second substrates;
a second, colored, non-polar liquid disposed between the first and second substrates, and the second liquid being immiscible with the first liquid;
a first insulating layer;
a first conductive layer; and
a second conductive layer;
wherein the first conductive layer is disposed on the first substrate away from the second substrate;
wherein the first insulating layer is disposed on the first conductive layer;
wherein the second conductive layer is disposed on the first insulating layer.

10. The electro-wetting display device of claim 9, wherein the first conductive layer comprise a plurality of first conductive lines parallel to each other, and the second conductive layer comprises a plurality of second conductive lines parallel to each other and orthogonal to the first conductive lines.

11. The electro-wetting display device of claim 10, further comprising a second insulating layer covering the first insulating layer and the second conductive layer.

12. The electro-wetting display device of claim 9, further comprising a plurality of side walls interposed between the first and second substrates and cooperating with the upper and second substrates to form a plurality of pixel units.
